(19) United States
(12) Patent Application Publication
(10) Pub. No.: US 2008/0147469 A1
(43) Pub. Date: Jun. 19, 2008

(54) Method to Enhance Calendar Event Management by Automating the Selection of Attendees Based on Grouping and Response

(76) Inventors: Jessica C. Murillo, Round Rock, TX (US); Gerald F. McBrearty, Austin, TX (US); Susann Keohane, Austin, TX (US); Johnny Shieh, Austin, TX (US); Shawn Mullen, Buda, TX (US)

Correspondence Address: HAMILTON & TERRILE, LLP;IBM Austin, P.O. BOX 203518, AUSTIN, TX, 78720, US

(21) Appl. No.: 11/610,182

(22) Filed: Dec. 13, 2006

(51) Int. Cl. G06Q 10/00

(52) U.S. Cl. 705/9

(57) ABSTRACT

An electronic calendar management system for managing a plurality of meeting invitees to limit meeting attendance to a predetermined number of attendees. A meeting planner schedules a meeting using an electronic calendar. A meeting attendee profile (MAP) is defined, comprising parameters that determine the criteria for selecting meeting invitees. The parameters of the MAP are applied against a pool of potential invitee profiles stored in a database to select invitees to the meeting. An electronic mail (email) meeting invitation is then generated and sent to the selected invitees. Invitee responses for each MAP are managed to limit meeting attendance to a predetermined number of attendees. The MAP can be revised by a remedial action, such as the generation of a revised email meeting invitation.

### BACKGROUND OF THE INVENTION

1. Field of the Invention

The present invention relates to computer software and more particularly, to the automated management of a calendar system.

2. Description of the Related Art

All too often, meetings are a fact of life in an organization. Deciding when they will be scheduled, where they will be held, and who should attend becomes challenging as their number and frequency increases. As a result, there has been a growing reliance on network-based work environments that support software applications such as personal information managers and electronic calendars designed to increase efficiency and productivity. The capabilities of these applications often extend beyond simply managing contacts, maintaining address lists, and task management to provide group management capabilities that enable a user to schedule a meeting and invite others to attend. Typically coupled through network-based email communications, invitees can receive notification of upcoming meetings and signify whether they accept or decline the invitation.

While an invitee's attendance may be mandatory or optional, managing the issuance, distribution, tracking, and status of their response to a meeting invitation can present difficulties, especially if not all of the invitees are required to attend. For example, an executive may schedule a meeting that requires the presence of a representative from each of six departments. While the manager of each department would be the ideal attendee, they may not be available or have schedule conflicts. Furthermore, if the manager is the only member of their department to receive the invitation and if he or she does not have access to email, then it is possible that no one from their department attends the meeting. Conversely, if the every member of the department receives an invitation, it is possible that the department will have too many representative attendees. In either case, management of meeting invitee responses can become tedious, time consuming and error-prone.

Prior art electronic calendar and scheduling approaches such as Lotus Notes Organizer provided by IBM address some of these issues. For example, a send broker and an action broker can be incorporated with a group scheduler and electronic calendar to automatically select invitees to a meeting by applying selection parameters to a profile database of potential attendees. Invitations to attend the meeting are then generated and sent to invitees who match the selection parameters, who may accept or decline. In response, the system notifies the meeting organizer for updates or modifications to the attendee list, such as selecting alternative invitees if the original invitee cannot attend. However, configuring and operating automated schedulers can be complex and time consuming, and the meeting organizer may lack the required expertise and time. Furthermore, the use of these systems to automatically select invitees may inhibit potential attendees from collaboratively deciding who within a group is best suited to attend the meeting. Moreover, none of these systems provide the ability to set a minimum or maximum limit on the number of accepted invitations, which can result in a meeting being under or over attended.

### SUMMARY

In accordance with an aspect of the invention, an electronic calendar management system is provided for managing a plurality of meeting invitees to limit meeting attendance to a predetermined number of attendees. In selected embodiments of the invention, a meeting planner schedules a meeting using an electronic calendar. At least one meeting attendee profile (MAP) is defined, comprising parameters that determine the criteria for selecting meeting invitees. The parameters of the MAP are applied against a pool of potential invitees, each of which has a corresponding invitee profile stored in a database. The parameters of the MAP are matched to the attendee parameters of the invitee profiles to select invitees to the meeting. An electronic mail (email) meeting invitation is then generated and sent to the selected invitees.

Invitee responses for each MAP are managed by a meeting attendance control system (MACS) to limit meeting attendance to a predetermined number of attendees. In one embodiment, MAP parameters limit attendance to at least one predetermined subset of an organization. In another embodiment, meeting attendance is limited to invitees assigned a predetermined functional role (e.g., manager, developer, financial controller, etc.) in an organization. In yet another embodiment, meeting attendance is limited to the attendee's availability to attend a meeting at a predetermined place, date and time. Meeting attendance is further limited by the MACS to a minimum and maximum number of attendees per MAP.

In selected embodiments, the MAP can be revised by a remedial action, such as the generation of an email message to one or more predetermined meeting invitees. In one embodiment, the email message requires an invitee to designate an alternate attendee to attend in place of an invitee declining a meeting invitation. In another embodiment, the email message comprises a replacement meeting invitation with an alternative meeting place, date, and time. In yet another embodiment, the email message requests the predetermined invitee to propose an alternative meeting place, date, and time. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 shows a flow chart of a meeting attendance control system (MACS) implemented in accordance with an embodiment of the invention;

FIG. 3 shows a hierarchical organization chart as implemented by a MACS to define a meeting attendee profile (MAP) used to select invitees for a first and second meeting;

FIGS. 4a-b show a MACS rules table for a MAP and a corresponding MACS invitee response table as implemented in a first embodiment of the invention; and

FIGS. 5a-b show a MACS rules table for a MAP and a corresponding MACS invitee response table as implemented in a second embodiment of the invention.

### DETAILED DESCRIPTION

An electronic calendar management system is disclosed for managing a plurality of meeting invitees to limit meeting attendance to a predetermined number of attendees. In selected embodiments, a meeting planner schedules a meeting using an electronic calendar. At least one meeting attendee profile (MAP) is defined, comprising parameters that determine the criteria for selecting meeting invitees. The parameters of the MAP are applied against a pool of potential invitees, each of which has a corresponding invitee profile stored in a database. The parameters of the MAP are matched to the attendee parameters of the invitee profiles to select invitees to the meeting. An electronic mail (email) meeting invitation is then generated and sent to the selected invitees. Invitee responses for each MAP are managed by a meeting attendance control system (MACS) to limit meeting attendance to a predetermined number of attendees. The MAP can be revised by a remedial action, such as the generation of a revised email meeting invitation to one or more predetermined meeting invitees.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

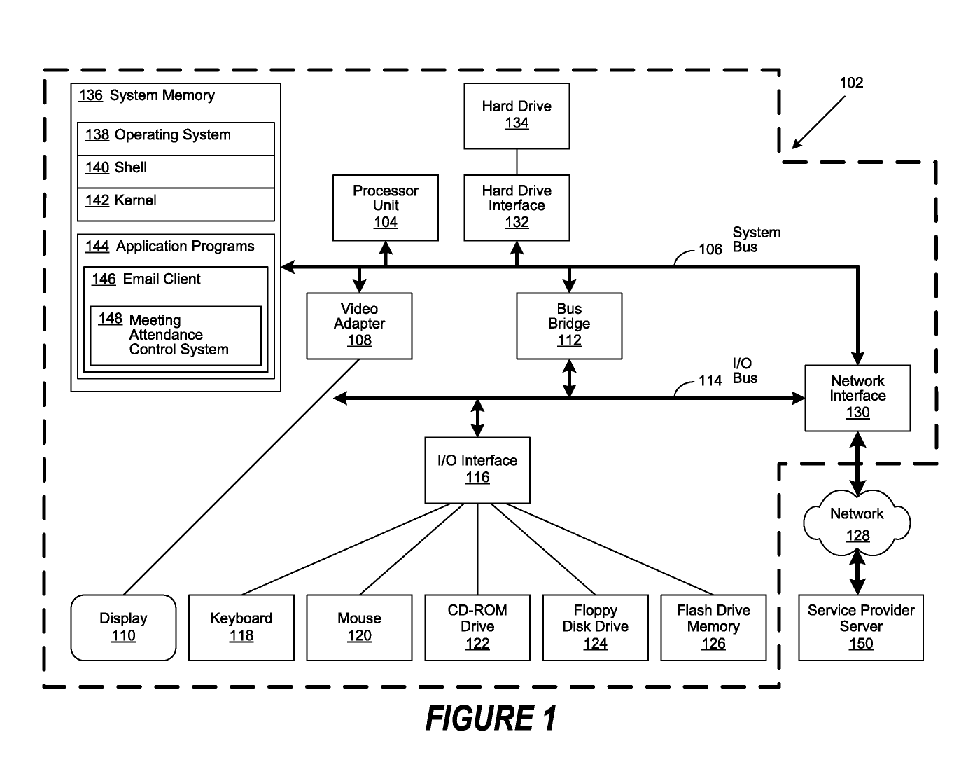

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 150 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

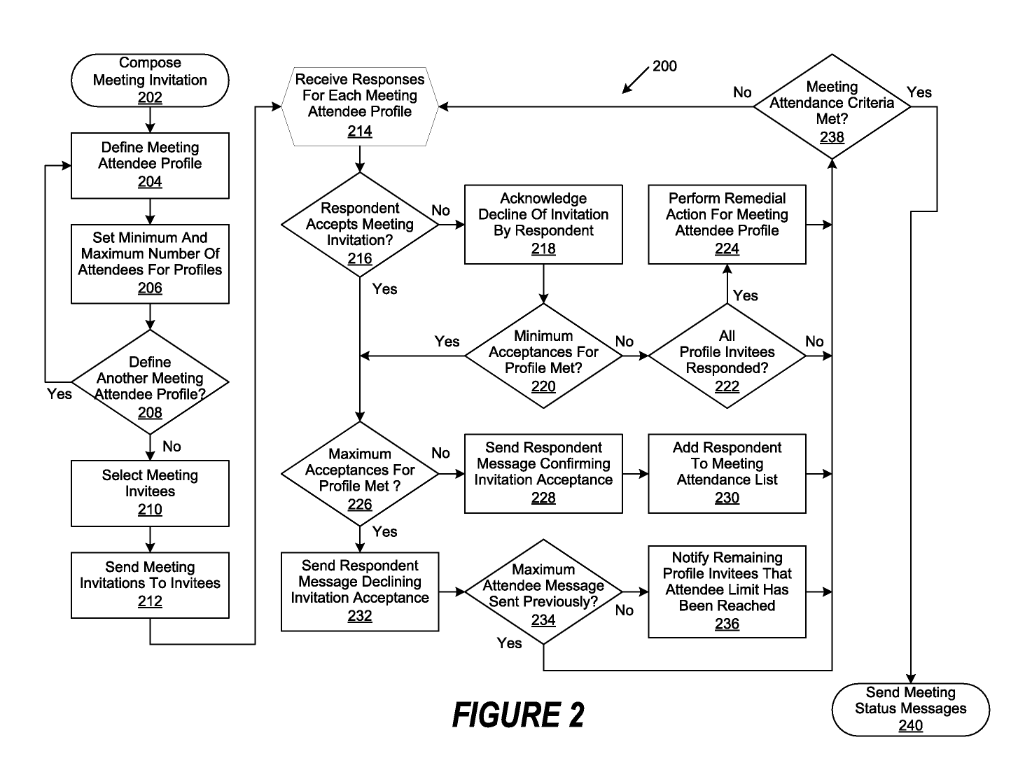

Application programs 144 may include an email client146. Email client 146 includes program modules and instructions enabling email messages to be sent and received. Email client 146 also includes a meeting attendance control system (MACS) 148. Email graphical Inbox mapper 148 includes code for implementing the processes described in FIGS. 2-8 described hereinbelow. In one embodiment, client computer 102 is able to download the meeting attendance control system (MACS) 148 from a service provider server 150.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 shows a flow chart of a meeting attendance control system (MACS) 200 implemented in accordance with an embodiment of the invention. In selected embodiments, a meeting organizer initiates attendance management of a planned meeting by composing a meeting invitation in step 202. A meeting attendee profile (MAP) is then defined in step 204 to establish attendee parameters. In one embodiment, attendee profile parameters are implemented requiring meeting attendees be a member of a predetermined subset of an organization. In another embodiment, parameters are implemented requiring an attendee to perform a predetermined functional role (e.g., manager, developer, financial controller, etc.) within an organization. In yet another embodiment, parameters are implemented requiring the attendee to be available to attend the meeting at the place, date and time specified in the meeting invitation. In step 206 the minimum and maximum number of meeting attendees for the attendee profile is established. If it is determined in step 208 that another MAP is to be defined, the process is repeated beginning with step 204.

Otherwise, meeting invitees matching the previously defined attendee meeting profiles are selected in step 210. In one embodiment, a rules engine is implemented to facilitate invitee selection by automatically applying MAP parameters to a profile database of potential invitees. Meeting invitations are then sent to the selected invitees in step 212, and their responses are received in step 214. If it is determined in step 216 that an invitee declines the invitation to the meeting, then a message is sent to the respondent in step 218 acknowledging that they have declined to accept the invitation. If it is determined in step 220 that the minimum number of invitation acceptances has not been met for the respondent's MAP, then it is determined in step 222 whether all invitees comprising the respondent's MAP have responded. If not all of the invitees comprising the respondent's MAP have responded, then it is determined in step 238 whether predetermined attendance criteria for the meeting has been met. If the predetermined attendance criteria have been met, then updated meeting status messages are sent in step 240. Otherwise, the receipt of invitee responses continues in step 214.

If it is determined in step 222 that all of the invitees comprising the respondent's MAP have responded, then remedial actions are performed in step 224 for the respondent's MAP. In one embodiment, remedial actions include the MACS generating a message to a predetermined invitee requiring the designation of an alternate attendee to attend in place of an invitee declining a meeting invitation. In another embodiment, remedial actions include generating a replacement meeting invitation with an alternative meeting place, date, and time. In yet another embodiment, remedial actions include allowing the invitee to propose an alternative meeting place, date and time. Once remedial actions have been completed, it is then determined in step 238 whether predetermined attendance criteria for the meeting has been met. If the predetermined attendance criteria have been met, then updated meeting status messages are sent in step 240. Otherwise, the receipt of invitee responses continues in step 214.

If it is determined in step 220 that the minimum number of invitation acceptances has been met for the respondent's MAP, then it is determined in step 226 whether the maximum number of acceptances has been met for the respondent's MAP. If the maximum number of invitation acceptances for the respondent's MAP has not been met, then the respondent is sent a message in step 228 confirming the receipt of their invitation acceptance. The respondent is then added to the meeting attendance list and a commitment entry is made in their electronic calendar in step 230. It is then determined in step 238 whether predetermined attendance criteria for the meeting has been met. If the predetermined attendance criteria have been met, then updated meeting status messages are sent in step 240. Otherwise, the receipt of invitee responses continues in step 214.

If it is determined in step 226 that the maximum number of invitation acceptances for the respondent's MAP has already been met, then the respondent is sent a message in step 232 declining their acceptance of the meeting invitation. It is then determined in step 234 whether the remaining invitees of the respondent's MAP have been previously notified that the attendee limit has been met and their participation is not required. If the remaining invitees of the respondent's MAP have been previously notified, it is then determined in step 238 whether predetermined attendance criteria for the meeting has been met. If the predetermined attendance criteria have been met, then updated meeting status messages are sent in step 240. Otherwise, the receipt of invitee responses continues in step 214. If the remaining invitees of the respondent's MAP have not been previously notified, then the remaining invitees are notified that the attendee limit for their invitee profile has been met and their participation is not required. It is then determined in step 238 whether predetermined attendance criteria for the meeting has been met. If the predetermined attendance criteria have been met, then updated meeting status messages are sent in step 240. Otherwise, the receipt of invitee responses continues in step 214.

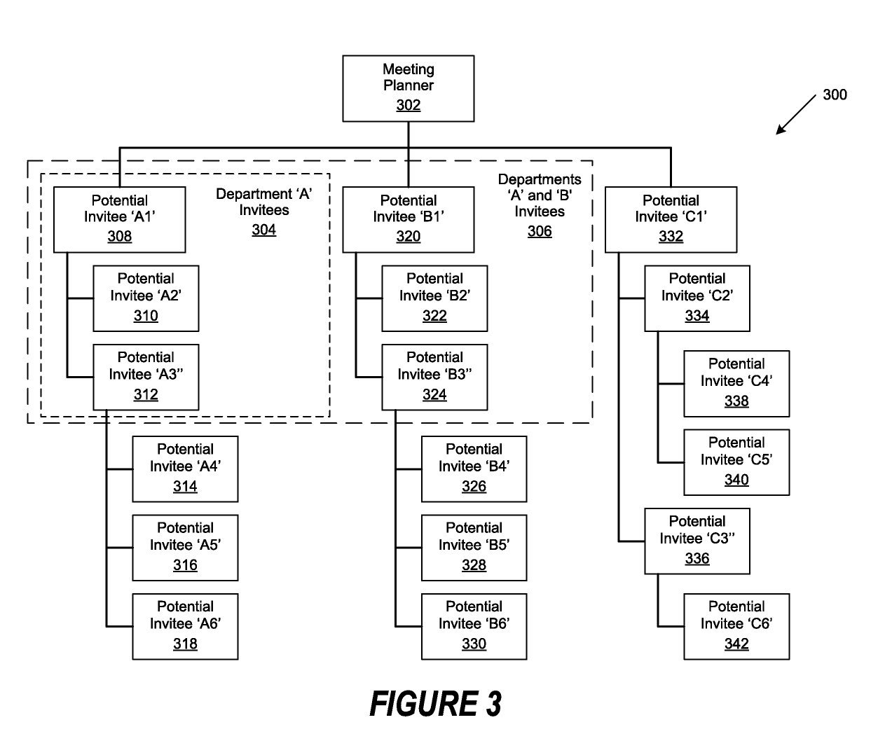

FIG. 3 shows a hierarchical organization chart 300 as implemented by a MACS to define a MAP used to select invitees for a first and second meeting. Hierarchical organization chart 300 comprises meeting planner 302 with direct reports comprising potential invitee ‘A1’ 308, ‘B1’ 320, and ‘C1’ 332. Potential invitee ‘A1’ 308 has direct reports comprising potential invitees ‘A2’ 310 and ‘A3’ 312, which has direct reports further comprising potential invitees ‘A4’ 314, ‘A5’ 316, and ‘A6’ 318. Likewise, potential invitee ‘B1’ 320 has direct reports comprising potential invitees ‘B2’ 322 and ‘B3’ 324, which has direct reports further comprising potential invitees ‘B4’ 326, ‘B5’ 328, and ‘B6’ 330. Similarly, potential invitee ‘C1’ 332 has direct reports comprising potential invitee ‘C2’ 334, which has direct reports further comprising potential invitees ‘C4’ 338, ‘C5’ 340, and potential invitee ‘C3’ 336, which has a direct report further comprising potential invitee ‘C6’ 342.

In an embodiment of the invention, meeting planner 302 defines a first MAP for department ‘A’ invitees 304 and a second MAP for department ‘A’ and ‘B’ invitees 306. The parameters of the first MAP are defined such that only the invitee profiles of potential invitees ‘A1’ 308 ‘A2’ 310 and ‘A3’ 312 match the meeting planner's 302 invitee selection criteria. The parameters of the second MAP are similarly defined such that only the invitee profiles of potential invitees ‘A1’ 308 ‘A2’ 310, ‘A3’ 312, ‘B1’ 320. ‘B2’ 322, and ‘B3’ 324 match the meeting planner's 302 invitee selection criteria.

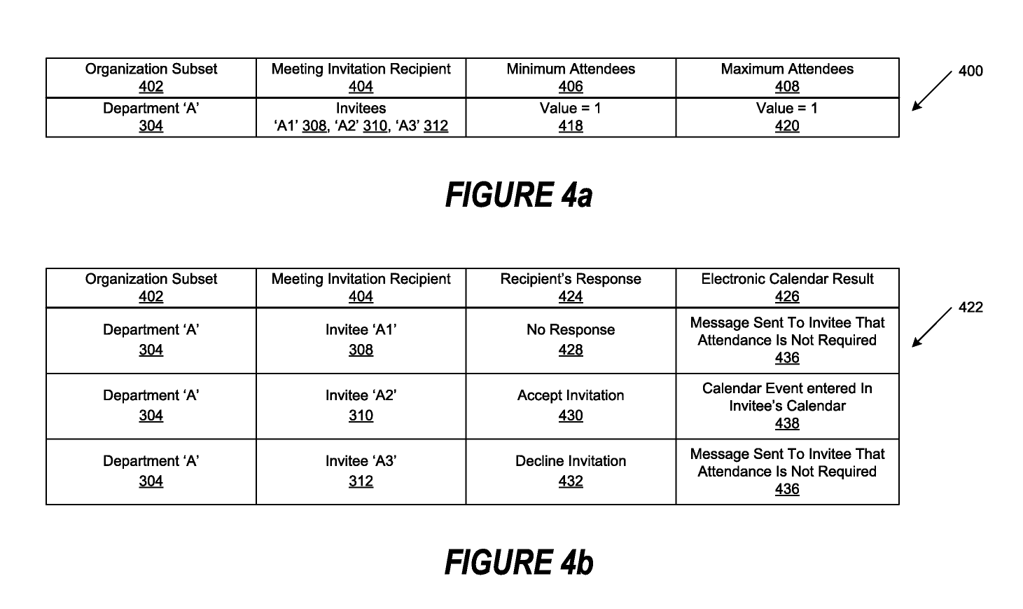

FIGS. 4a-b show a MACS rules table 400 for a meeting invitee profile and a corresponding MACS invitee response table 422 as implemented in a first embodiment of the invention. In this embodiment, the MACS rules table 400 comprises columns for one or more predetermined organization subsets 402, one or more meeting invitation recipients 404, minimum number of attendees 406, and maximum number of attendees 408. Organization subset column 402 comprises department ‘A’ 304 and meeting invitation recipient column 404 comprises invitees ‘A1’ 308, ‘A2’ 310, and ‘A3’ 312. The value of minimum attendees' column 406 equal to 1 and the value of maximum attendees' column 408 are likewise equal to 1.

As such, the rule represented by the MACS rules table 400 signifies that all of the invitees ‘A1’ 308, ‘A2’ 310, ‘A3’ 312 comprising meeting invitation recipient column 404 meet the selection parameters to represent department ‘A’ 304. However, at least one, but no more than one, of the invitees ‘A1’ 308, ‘A2’ 310, ‘A3’ 312 is allowed to attend the meeting. In this embodiment, the MACS rules table 400 is used to structure the electronic calendar meeting invitation entry as:
To: Department ‘A’ 304: Invitee ‘A1’ 308,
   Department ‘A’ 304: Invitee ‘A2’ 310,
   Department ‘A’ 304, Invitee ‘A3’ 312,
   Minimum Attendance 406: Department ‘A’ 304: 1
   Maximum Attendance 408: Department ‘A’ 304: 1
From: Meeting Planner
Subject: Department ‘A’ 304 Review
Date: June 6, 2006
Time: 9:00 AM
Location: Conference Room

The MACS invitee response table 422 comprises organization subset column 402, meeting invitation recipient column 404, recipient's response column 424, and electronic calendar result column 426. Organization subset column 402 comprises department ‘A’ 304 and meeting invitation recipient column 304 comprises invitees ‘A1’ 308, ‘A2’ 310, and ‘A3’ 312. Recipient's response column 424 comprises “no response” 428, “accept invitation” 430, and “decline invitation” 432. Electronic calendar result column 426 comprises two instances of “message sent to invitee that attendance is not required” 436 and one instance of “calendar event entered in invitee's calendar” 438.

After receiving the electronic calendar meeting invitation entry described in greater detail hereinabove, invitee ‘A1’ 308, fails to respond 428, invitee ‘A2’ 312 accepts the invitation 430, and invitee ‘A3’ 312 declines the invitation 432. As a result, invitee ‘A1’ 308 and invitee ‘A3’ 312 receive an electronic calendar results message that “their attendance is not required” 436, whereas invitee ‘A2’ 310 receives an electronic calendar result of “calendar event entered in invitee's calendar” 438. It will be apparent to those of skill in the art that the respective responses 428, 430, 432 from invitees ‘A1’ 308, ‘A2’ 310, and ‘A3’ 312 satisfy the rules depicted in MACS rules table 400.

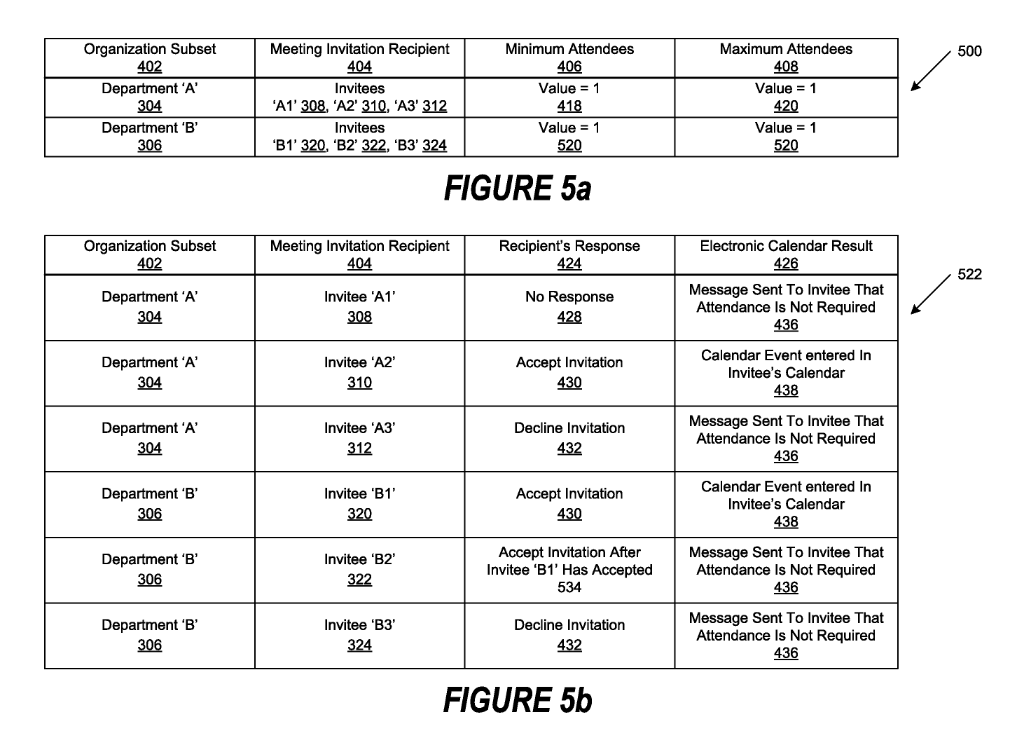

FIGS. 5a-b show a MACS rules table 500 for a meeting invitee profile and a corresponding MACS invitee response table 522 as implemented in a second embodiment of the invention. In this embodiment, the MACS rules table 500 comprises columns for one or more predetermined organization subsets 402, one or more meeting invitation recipients 404, minimum number of attendees 406, and maximum number of attendees 408. Organization subset column 402 comprises department ‘A’ 304 and department ‘B’ 306, with the meeting invitation recipient column 404 comprising invitees ‘A1’ 308, ‘A2’ 310, ‘A3’ 312, ‘B1’ 320, ‘B2’ 322, and ‘B3’ 324. The value of minimum attendees' column 406 equal to 1, and the value of maximum attendees' column 408 are likewise equal to 1.

As such, the rule represented by the MACS rules table 500 signifies that all of the invitees ‘A1’ 308, ‘A2’ 310, ‘A3’ 312 comprising meeting invitation recipient column 404 meet the selection parameters to represent department ‘A’ 304. Likewise, all of the invitees ‘B1’ 320, ‘B2’ 322, ‘B3’ 324 comprising meeting invitation recipient column 404 meet the selection parameters to represent department ‘B’ 306. However, at least one, but no more than one, of the invitees ‘A1’ 308, ‘A2’ 310, ‘A3’ 312 and at least one, but no more than one, of the invitees ‘B1’ 320, ‘B2’ 322, ‘B3’ 324 are allowed to attend the meeting. In this embodiment, the MACS rules table 500 is used to structure the electronic calendar meeting invitation entry as:
To: Department ‘A’ 304: Invitee ‘A1’ 308,
   Department ‘A’ 304: Invitee ‘A2’ 310,
   Department ‘A’ 304, Invitee ‘A3’ 312,
   Department ‘B’ 306: Invitee ‘B1’ 320,
   Department ‘B’ 306: Invitee ‘B2’ 322,
   Department ‘B’ 306, Invitee ‘B3’ 324,
   Minimum Attendance 406: Department ‘A’ 304: 1
   Maximum Attendance 408: Department ‘A’ 304: 1
   Minimum Attendance 406: Department ‘B’ 306: 1
   Maximum Attendance 408: Department ‘B’ 306: 1
From: Meeting Planner
Subject: Department ‘A’ 304 and Department ‘B’ 306 Review
Date: June 6, 2006
Time: 9:00 AM
Location: Conference Room

The MACS invitee response table 522 comprises organization subset column 402, meeting invitation recipient column 404, recipient's response column 424, and electronic calendar result column 426. Organization subset column 402 comprises department ‘A’ 304 and department ‘B’ 306, with the meeting invitation recipient column 404 comprising invitees ‘A1’ 308, ‘A2’ 310, ‘A3’ 312, ‘B1’ 320, ‘B2’ 322, and ‘B3’ 324. Recipient's response column 424 comprises “no response” 428, “accept invitation” 430, “decline invitation” 432, and “accept invitation after invitee B1 has accepted” 534. Electronic calendar result column 426 comprises four instances of “message sent to invitee that attendance is not required” 436 and two instances of “calendar event entered in invitee's calendar” 438.

After receiving the electronic calendar meeting invitation entry described in greater detail hereinabove, invitee ‘A1’ 308, fails to respond 428, invitees ‘A2’ 310 and ‘B1’ 320 accept the invitation 430, and invitee ‘A3’ 312 declines the invitation 432. However, invitee ‘B2’ 322 accepts the invitation after invitee ‘B1’ 320 accepts the invitation for department ‘B’ 306. As a result, invitees ‘A1’ 308, ‘A3’ 310, ‘B3’ 412 receive an electronic calendar results message that “their attendance is not required” 436, whereas invitees ‘A2’ 310 and ‘B1’ 320 receive an electronic calendar result of “calendar event entered in invitee's calendar” 438. Similarly, invitee ‘B2’ 322 also receives an electronic calendar results message that “their attendance is not required” 436 due to accepting the invitation after invitee ‘B1’ 320 has already accepted the invitation to represent department ‘B’ 306. It will be apparent to those of skill in the art that the respective responses 428, 430, 432, 534 from invitees ‘A1’ 308, ‘A2’ 310, ‘A3’ 312, ‘B1’ 320, ‘B2’ 322, and ‘B3’ 324 satisfy the rules depicted in MACS rules table 500.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “tan” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method for managing a plurality of meeting invitees to limit meeting attendance to a predetermined number of attendees, comprising:
scheduling a meeting using an electronic calendar;
defining at least one meeting attendee profile (MAP), the MAP comprising predetermined attendee parameters;
selecting a predetermined plurality of invitees from a pool of potential invitees, the potential invitees comprising invitee profiles stored in a database, where the database is operable to match invitee parameters comprising invitee profiles to the predetermined attendee parameters of the MAP;
generating at least one electronic mail (email) meeting invitation, the email meeting invitation deliverable to the selected invitees; and
limiting invitee responses to the email meeting invitation to the predetermined number of meeting attendees.

2. The method of claim 1, wherein the predetermined attendee parameters comprise at least one predetermined subset of an organization.

3. The method of claim 1, wherein the predetermined attendee parameters comprise a predetermined functional role within an organization.

4. The method of claim 1, wherein the predetermined attendee parameters comprise the attendee's availability to attend a meeting at a predetermined place, date and time.

5. The method of claim 1, wherein meeting attendance is limited to a predetermined minimum number of attendees.

6. The method of claim 1, wherein meeting attendance is limited to a predetermined maximum number of attendees.

7. The method of claim 1, wherein the MAP is operable to be revised by a remedial action, the remedial action comprising the generation of an email message to a predetermined meeting invitee.

8. A system comprising:
a processor;
a data bus coupled to the processor; and
a computer-usable medium embodying computer program code, the computer-usable medium being coupled to the data bus, the computer program code for managing a plurality of meeting invitees to limit meeting attendance to a predetermined number of attendees and comprising instructions executable by the processor and configured for:
scheduling a meeting using an electronic calendar;
defining at least one meeting attendee profile (MAP), the MAP comprising predetermined attendee parameters;
selecting a predetermined plurality of invitees from a pool of potential invitees, the potential invitees comprising invitee profiles stored in a database, where the database is operable to match invitee parameters comprising invitee profiles to the predetermined attendee parameters of the MAP;
generating at least one electronic mail (email) meeting invitation, the email meeting invitation deliverable to the selected invitees; and
limiting invitee responses to the email meeting invitation to the predetermined number of meeting attendees.

9. The system of claim 8, wherein the predetermined attendee parameters comprise at least one predetermined subset of an organization.

10. The system of claim 8, wherein the predetermined attendee parameters comprise a predetermined functional role within an organization.

11. The system of claim 8, wherein the predetermined attendee parameters comprise the attendee's availability to attend a meeting at a predetermined place, date and time.

12. The system of claim 8, wherein meeting attendance is limited to a predetermined minimum number of attendees.

13. The system of claim 8, wherein meeting attendance is limited to a predetermined maximum number of attendees.

14. The system of claim 8, wherein the MAP is operable to be revised by a remedial action, the remedial action comprising the generation of an email message to a predetermined meeting invitee.

15. A computer-usable medium embodying computer program code, the computer program code comprising computer executable instructions configured for:
scheduling a meeting using an electronic calendar;
defining at least one meeting attendee profile (MAP), the MAP comprising predetermined attendee parameters;
selecting a predetermined plurality of invitees from a pool of potential invitees, the potential invitees comprising invitee profiles stored in a database, where the database is operable to match invitee parameters comprising invitee profiles to the predetermined attendee parameters of the MAP;
generating at least one electronic mail (email) meeting invitation, the email meeting invitation deliverable to the selected invitees; and
limiting invitee responses to the email meeting invitation to the predetermined number of meeting attendees.

16. The computer-usable medium of claim 15, wherein the predetermined attendee parameters comprise at least one predetermined subset of an organization.

17. The computer-usable medium of claim 15, wherein the predetermined attendee parameters comprise a predetermined functional role within an organization.

18. The computer-usable medium of claim 15, wherein the predetermined attendee parameters comprise the attendee's availability to attend a meeting at a predetermined place, date and time.

19. The computer-usable medium of claim 15, wherein meeting attendance is limited to a predetermined minimum number of attendees.

20. The computer-usable medium of claim 1 5, wherein meeting attendance is limited to a predetermined maximum number of attendees.

21. The computer-usable medium of claim 15, wherein the MAP is operable to be revised by a remedial action, the remedial action comprising the generation of an email message to a predetermined meeting invitee.
